(19) United States
(12) Patent Application Publication
(10) Pub. No.: US 2015/0048117 A1
(43) Pub. Date: Feb. 19, 2015

(54) BEVERAGE DISPENSING AND PRESSURIZER SYSTEM

(71) Applicants: Wai T. Lam, Jericho, NY (US); Wayne Lam, Jericho, NY (US); Jonathan A. Tyler, Yorktown Heights, NY (US)

(72) Inventors: Wai T. Lam, Jericho, NY (US); Wayne Lam, Jericho, NY (US); Jonathan A. Tyler, Yorktown Heights, NY (US)

(21) Appl. No.: 14/091,159

(22) Filed: Nov. 26, 2013

Related U.S. Application Data
(63) Continuation of application No. 13/970,440, filed on Aug. 19, 2013.

(51) Int. Cl. B67D 1/04; F16L 29/00

(52) U.S. Cl. CPC B67D 1/0437; F16L 29/00
USPC 222/146.6; 222/212; 251/148

(57) ABSTRACT

An apparatus comprises an inflatable object adapted to be inserted into a beverage container, and a mechanism adapted to inject air into the inflatable object in response to a decrease in pressure within the beverage container. The beverage container may hold a carbonated beverage, for example. In one embodiment, the mechanism is adapted to maintain an equilibrium between a first partial pressure within the carbonated beverage and a second partial pressure of an air pocket within the beverage container. In one embodiment, the apparatus comprises a cap adapted to fit onto the beverage container, wherein the inflatable object is coupled to the cap. The cap may comprise a tube connecting the cap and the inflatable object, wherein the tube comprises a channel adapted to transmit air to the inflatable object.

### TECHNICAL FIELD

This specification relates generally to beverage dispensing and pressurizing systems and more particularly, to systems for dispensing and pressurizing carbonated beverages.

### BACKGROUND

Carbonated beverages, also referred to as soft drinks or sodas, are among the most popular beverages consumed today. A carbonated beverage contains carbon dioxide dissolved in water. Typically, a large amount of carbon dioxide is dissolved in the soft drink to ensure a minimal effervescence when the beverage is opened or poured into a glass.

Dispensing a carbonated beverage causes a significant loss of carbon dioxide. This loss of carbonation occurs in both the beverage dispensed and in the beverage remaining in the bottle. In either case, the beverage “goes flat” and the taste is less appealing to most people.

Opening a bottle containing a carbonated beverage and pouring a drink reduces the effervescence of the beverage in two ways. Opening the bottle releases carbon dioxide which has escaped from the beverage during storage. In addition, the act of pouring disturbs the beverage, causing the release of the dissolved carbon dioxide from both the beverage being dispensed and the beverage remaining in the bottle. Once carbon dioxide is released, it does not re-dissolve into the beverage.

Carbonated beverages are purchased in a variety of sizes. One popular size is the twelve ounce bottle or can. Another popular size is the two liter bottle. Use of larger size containers provides a number of advantages. Larger size containers offer lower cost per ounce. Larger size containers also consume fewer resources, and are thus more environmentally friendly. Also, because the soda is typically poured manually into a cup or glass, the user may gauge more accurately how much to dispense, thus resulting in less waste.

However, larger containers are associated with a number of problems. A larger container, such as a two-liter bottle, holds a larger quantity of soda, which is often only partially consumed; the container is typically then closed and stored, for example in a refrigerator. However, if the beverage is not consumed immediately, the carbonated beverage inside the bottle often goes flat after the bottle in storage (e.g., in the refrigerator). Also, large bottles are less convenient to handle than smaller containers. In addition, frequently removing a large beverage container from the refrigerator consumes electricity.

Several existing products exist to address some of the problems discussed above. Some simple dispensers allow soda to be pushed out of a bottle by the pressure of the carbon dioxide without opening the cap. This solution can reduce the release of carbon dioxide within the bottle. However, this solution does not prevent the release of carbon dioxide indefinitely. After a portion of the beverage is consumed, a volume of air is created in the bottle, and all of a portion of the remaining carbon dioxide is released, causing the beverage to go flat.

Another existing solution is to use a pressure pumps to pump air into the bottle each time the beverage is poured. This solution is cumbersome because pumping is required every time the bottle is opened. In addition, this solution is not fully effective because each time the cap is opened, some of the carbon dioxide escapes.

Existing solutions do not successfully prevent carbonated beverages from going flat. Furthermore, existing solutions do not address other problems, such as inconvenience and environmental issues (e.g., the need for frequent opening of the refrigerator).

### SUMMARY

In accordance with an embodiment, an apparatus comprises an inflatable object adapted to be inserted into a beverage container, and a mechanism adapted to inject air into the inflatable object in response to a decrease in pressure within the beverage container, thereby inflating the inflatable object. The beverage container may hold a carbonated beverage, for example.

In one embodiment, the mechanism is adapted to maintain an equilibrium between a first partial pressure within the carbonated beverage and a second partial pressure of an air pocket within the beverage container.

In another embodiment, the apparatus also comprises a cap adapted to fit onto the beverage container, wherein the inflatable object is coupled to the cap. The cap may comprise a tube connecting the cap and the inflatable object, wherein the tube comprises a channel adapted to transmit air to the inflatable object.

In one embodiment, a volume of air sufficient to cause the inflatable object to expand sufficiently to occupy a volume vacated by the dispensed beverage is injected into the inflatable object.

In accordance with another embodiment, a system for dispensing a carbonated beverage is provided. The system includes a compressed air reservoir adapted to store pressurized air at a selected pressure, and a dispensing mechanism adapted to dispense a carbonated liquid from a container. The system also includes an inflatable object adapted fit inside the container, and a channel connecting the compressed air reservoir and the inflatable object, wherein the channel is adapted to allow pressurized air to flow from the compressed air reservoir to the inflatable object. In response to a carbonated liquid being dispensed from the container, pressurized air flows from the compressed air reservoir into the inflatable object, causing the inflatable object to expand inside the container.

In one embodiment, the container comprises a bottle. The inflatable object may comprise a balloon. The channel may comprise at least one tube.

In another embodiment, the system includes a cap adapted to fit onto the bottle, the cap comprising at least one tube adapted to extend into the container when the cap is fitted onto the container, wherein the inflatable object is coupled to the at least one tube. The cap further comprises a second channel allowing pressurized air to flow through the cap into the inflatable object via the at least one tube.

In another embodiment, the cap comprises a twist-on cap adapted to attach to a two liter soda bottle. The compressed air reservoir stores air at a pressure selected to inflate the inflatable object within the container sufficiently to cause an air pocket within the container to maintain a substantially constant volume.

In accordance with another embodiment, a connector assembly is provided. The connector assembly comprises an outer casing defining a cavity, an inlet, an outlet, a first channel connecting the cavity and an outlet, and a second channel connecting the cavity and an inlet. The connector assembly also includes a hollow sliding valve disposed in the cavity, the sliding valve having a side hole and a top hole, wherein the sliding valve has a first position and a second position. The side hole is aligned with the second channel and a flow of air between the second channel and the cavity is permitted when the sliding valve is in the first position. The side hole is not aligned with the second channel and the flow of air between the second channel and the cavity is blocked when the sliding valve is in the second position. The connector assembly further comprises an engaging mechanism disposed within the cavity, the engaging mechanism being adapted to receive threads of a beverage container. The sliding valve moves from the second position to the first position in response to a beverage container being engaged with the engaging mechanism.

In one embodiment, the first channel is adapted to dispense beverage from the beverage container when a beverage container is engaged with the engaging mechanism. The beverage container may be a two liter soda bottle, for example.

In another embodiment, the connector assembly further comprises a well disposed in the cavity, wherein a spring is disposed in the well, and the sliding valve is disposed in the well and attached to the spring.

In accordance with another embodiment, a beverage dispensing system is provided. The beverage dispensing system includes a plurality of bottle holders adapted to hold a plurality of two liter bottles each containing a liquid, a cooling system adapted to cool the plurality of two liter bottles, and one or more dispensing mechanisms adapted to dispense liquid from the plurality of two liter bottles. The system further includes a pressurized air reservoir adapted to hold pressurized air, and at least one connector assembly coupled to the pressurized air reservoir, the at least one connecting assembly being adapted to engage a two liter bottle, allow liquid to be dispensed from the two liter bottle, and allow pressurized air to flow from the pressurized air reservoir into the two liter bottle.

In one embodiment, the cooling system comprises a plurality of cooling loops, a plurality of Peltier plates, a heat sink, and a ventilation fan.

In another embodiment, the beverage dispensing system further comprises a stopper cap adapted to be attached to the two liter bottle, the stopper cap being further adapted to be connected to the at least one connector assembly.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows an external view of a beverage dispensing system in accordance with an embodiment;

FIG. 2 shows a cut-away view of the interior of a beverage dispensing system, in accordance with an embodiment;

FIG. 3 shows a cut-away view of the interior of a beverage dispensing system in accordance with an embodiment;

FIG. 4 shows cooling system of a beverage dispensing system in accordance with an embodiment;

FIG. 5 is a top-down view of a cooling loop, a connector, a cooling plate, and a heat sink in accordance with an embodiment;

FIG. 6 shows a cross-section view of certain components of a beverage dispensing system in accordance with an embodiment;

FIG. 7 shows a compressed air reservoir in accordance with an embodiment;

FIGS. 8A-8C illustrate a user replacing an ordinary cap of a beverage bottle with a stopper cap in accordance with an embodiment;

FIG. 9 shows components of a stopper cap in accordance with an embodiment;

FIG. 10 is a top view of a stopper cap in accordance with an embodiment;

FIG. 11 shows a stopper cap attached to a bottle in accordance with an embodiment;

FIG. 12 shows a bottle with a stopper cap and a connector assembly in accordance with an embodiment;

FIG. 13 shows a sliding valve in accordance with an embodiment;

FIG. 14 shows a bottle and a stopper cap twisted partially into a connector assembly in accordance with an embodiment;

FIG. 15 shows a bottle and a stopper cap twisted partially into a connector assembly in accordance with an embodiment;

FIG. 16 shows a bottle and a stopper cap connected to a connector assembly in accordance with an embodiment;

FIG. 17 shows a bottle and a stopper cap connected to a connector assembly in accordance with an embodiment;

FIG. 18 shows a bottle and a stopper cap connected to a connector assembly in accordance with an embodiment;

FIG. 19 shows a bottle and a stopper cap connected to a connector assembly in accordance with an embodiment;

FIG. 20 shows a bottle and a stopper cap connected to a connector assembly in accordance with an embodiment;

FIG. 21 shows a bottle and a stopper cap connected to a connector assembly in accordance with an embodiment;

FIG. 22 shows a bottle and a stopper cap connected to a connector assembly in accordance with an embodiment; and

FIG. 23 shows a system for dispensing a carbonated beverage from a container in accordance with an embodiment.

### DETAILED DESCRIPTION

In accordance with an embodiment, an apparatus comprises an inflatable object adapted to be inserted into a beverage container, and a mechanism adapted to inject air into the inflatable object in response to a decrease in pressure within the beverage container, thereby inflating the inflatable object. The beverage container may hold a carbonated beverage, for example. The mechanism may be adapted to maintain an equilibrium between a first partial pressure within the carbonated beverage and a second partial pressure of an air pocket within the beverage container. In another embodiment, the apparatus comprises a cap adapted to fit onto the beverage container, wherein the inflatable object is coupled to the cap. The cap may comprise a tube connecting the cap and the inflatable object, wherein the tube comprises a channel adapted to transmit air to the inflatable object. In one embodiment, a volume of air sufficient to cause the inflatable object to expand sufficiently to occupy a volume vacated by the dispensed beverage is injected into the inflatable object.

In accordance with another embodiment, a beverage dispensing system is provided. The beverage dispensing system comprises a plurality of bottle holders adapted to hold a plurality of two-liter bottles each containing a liquid. The beverage dispensing system also includes a cooling system adapted to cool the plurality of two-liter bottles, and one or more dispensing mechanisms adapted to dispense liquid from the plurality of two-liter bottles. The beverage dispensing system further comprises a pressurized air reservoir adapted to hold pressurized air, and at least one connecting assembly coupled to the pressurized air reservoir, the at least one connecting assembly being adapted to inject pressurized air into each of the plurality of two-liter bottles.

In accordance with another embodiment, a user may replace an ordinary cap (of a two-liter bottle, for example) with an inventive stopper cap, and use the stopper cap to connect the bottle to a connector assembly. The stopper cap and the connector assembly allow a carbonated beverage to be dispensed from the bottle and further allow pressurized air to be injected into an inflatable object within the bottle to control a volume of air within the bottle. Controlling a volume of air within the bottle may, for example, prevent carbon dioxide within the beverage from vaporizing and consequently prevent the beverage from going flat.

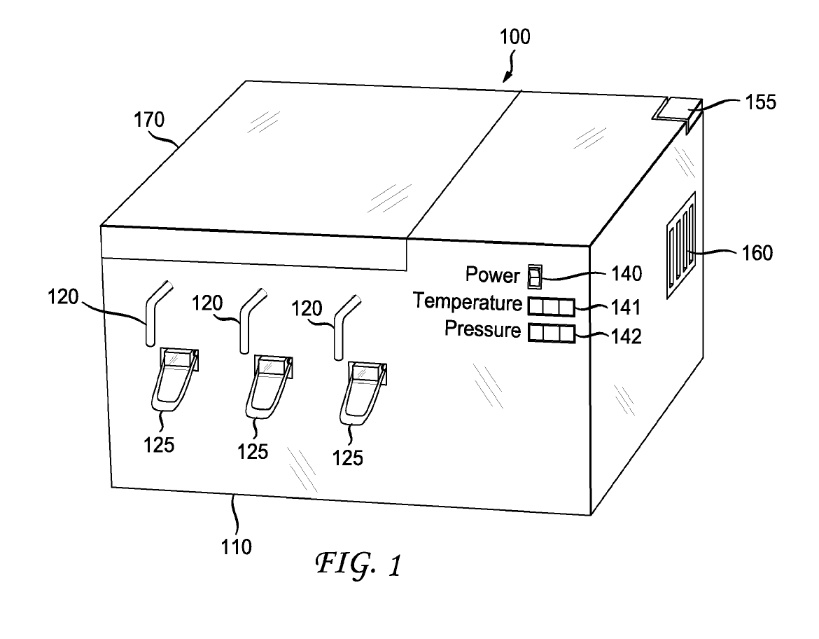

FIG. 1 shows an external view of a beverage dispensing system in accordance with an embodiment. Beverage dispensing system 100 comprises a container 110, a plurality of dispensing mechanisms 120, a plurality of dispensing handles 125, and a plurality of displays 140, 141, 142. Beverage dispensing system 100 also includes a ventilation opening 160 and a pump handle 155.

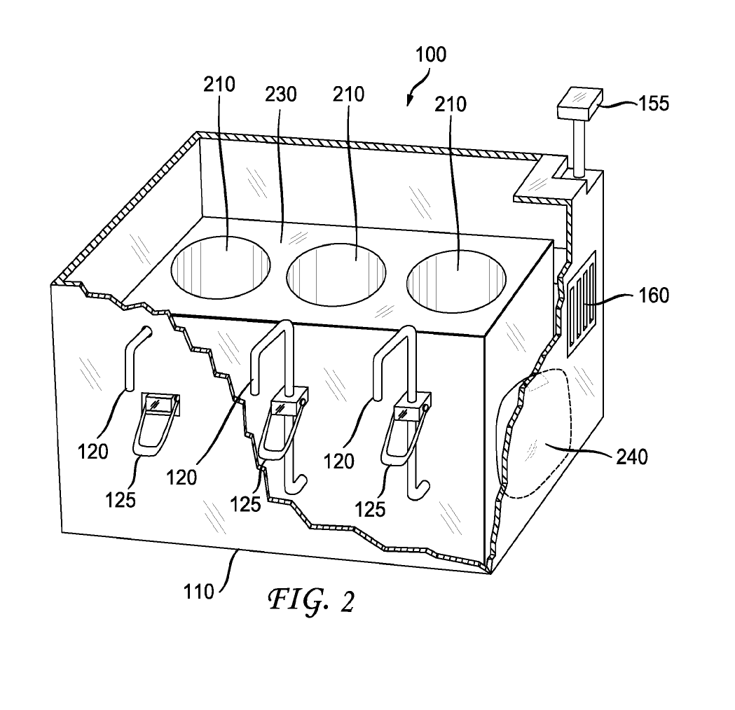

FIG. 2 shows a cut-away view of the interior of beverage dispensing system 100, in accordance with an embodiment. Beverage dispensing system 100 comprises a bottle holder 230, which surrounds a portion of the interior of container 110. Bottle holder 230 comprises an insulating material, such as foam, for example. Bottle holder 230 comprises a plurality of chambers 210 adapted to hold bottles of a selected size. In the illustrative embodiment, bottle holder 230 comprises three chambers 210.

Beverage dispensing system 100 also comprises a compressed air providing apparatus 240. In the illustrative embodiment, compressed air providing apparatus 240 comprises a compressed air reservoir. In other embodiments, compressed air providing apparatus 240 may include any type of apparatus adapted to provide compressed air, such as an air pump (powered or manual), or other type of device.

As shown in FIGS. 1 and 2, container 110 serves as the container of various components of beverage system 100, and also holds beverage bottles. The exterior portion of container 110 includes dispenser mechanisms 120 and dispensing handles 125, which may be operated by a user.

Pump handle 155 operates a manually operated pressure pump (not shown in FIGS. 1 and 2). Pump handle 155 is accessible to a user from the exterior of container 110.

Displays 140, 141, 142 are mounted on the exterior of container 110. In various embodiments, selected parameters relating to the operational status of beverage dispensing system 100 may be displayed on the displays. In the illustrative embodiment, displays 140, 141, 142 display, respectively, a power level, one or more temperature readings (which may include one or more of current internal temperature, current external temperature, etc.), and a measure of air pressure within the bottles. In other embodiments, more or fewer than three displays may be used, and other types of information may be displayed.

In the illustrative embodiment of FIG. 2, beverage dispensing system 100 may hold up to three (3) 2-liter bottles of selected sodas or other beverages, which may be carbonated or non-carbonated. FIG. 2 is illustrative only and should not be construed as limiting. In other embodiments, a beverage dispensing system may hold more or fewer than three bottles. Also, in other embodiments, a beverage dispensing system may be adapted to hold smaller or larger bottles, or other types of beverage containers.

Advantageously, beverage dispensing system 100 may hold one or more large size bottles and allow a user to dispense small amounts into a cup in an economical and environmentally-friendly manner.

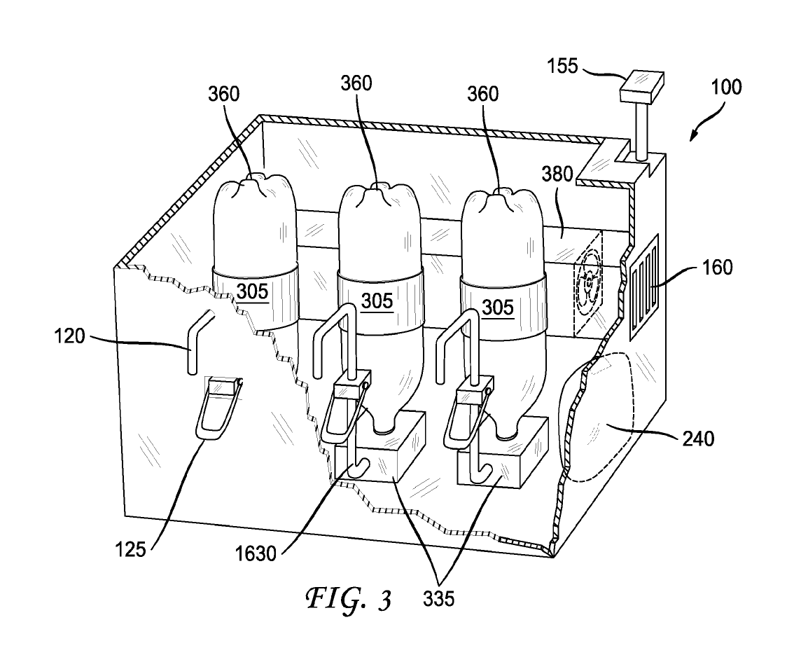

FIG. 3 shows a cut-away view of the interior of beverage dispensing system 100 in accordance with an embodiment. In the illustrative embodiment of FIG. 3, the exterior of bottle holder 230 is omitted in order to show the contents thereof. Three bottle cooling loops 305 are attached to a ventilation chamber 380. Each cooling loop 305 has a diameter sufficient to hold a beverage bottle of a selected size. In the illustrative embodiment of FIG. 3, each cooling loop 305 holds a two-liter bottle 360. In other embodiments, a cooling loop 305 may hold a bottle of a different size. Each bottle 360 is further secured within a respective bottle connector assembly 335.

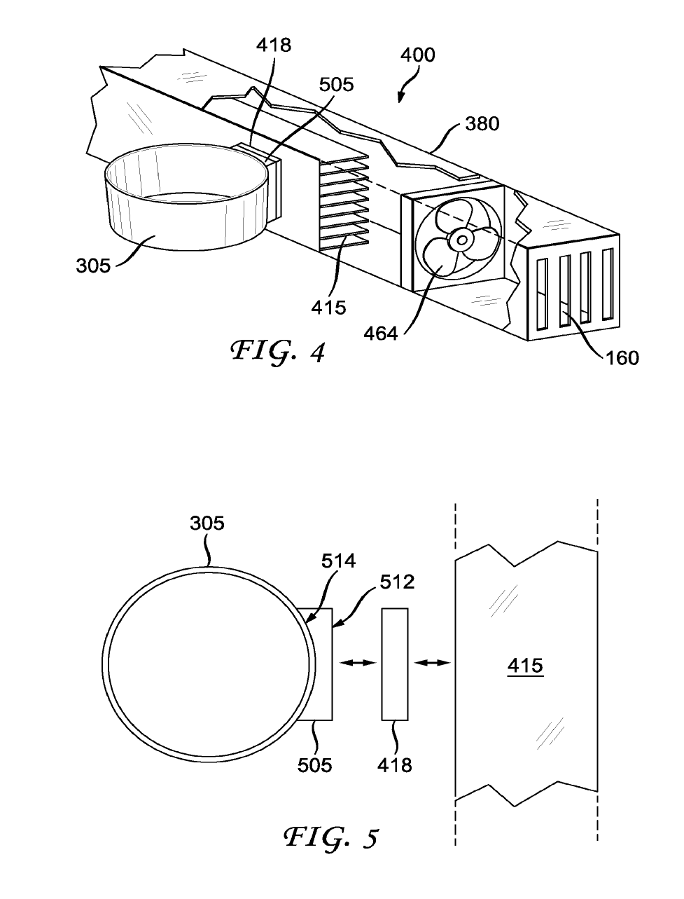

Beverage dispensing system 100 includes a cooling system 400 which cools the beverages stored in bottles 360, and maintains the coolness of the beverages in the bottles. FIG. 4 shows cooling system 400 in accordance with an embodiment. Ventilation chamber 380, ventilation opening 160, and cooling loops 305 are components of cooling system 400. While cooling system 400 includes a plurality of cooling loops 305, only one cooling loop 305 is shown in FIG. 4 for convenience. Cooling system 400 further comprises a heat sink 415, and a ventilation fan 464.

As shown in FIG. 4, each cooling loop 305 is connected to a semiconductor cooling plate 418 via a connector 505. Each cooling plate 418 is attached to, or integrated with, heat sink 415. During operation, one side of cooling plate 418 remains cool, while the other side of cooling plate 418 generates heat. Cooling loop 305 is connected to the cool side of cooling plate 418. The metal area of cooling loop 305 is thermally conductive and consequently facilitates a cooling process which cools the beverage through the surface of the bottle. The warmer side of cooling plate 418 is connected to heat sink 415. Ventilation fan 464 is arranged to direct the air flow to remove heat through ventilation opening 160 to the exterior of beverage dispensing system 100. A temperature sensor (not shown) may be used to control electrical power to cooling plates 418 and to fan 464. When the beverage in bottles 360 is sufficiently cool, cooling plates 418 are turned off.

Referring again to FIG. 2, bottle holder 230 (in which the bottles are held) is insulated to ensure the effectiveness and efficiency of cooling system 400.

In one embodiment, a 12VDC power supply (not shown) is used to power cooling system 400. In another embodiment, direct car battery input may be used. In another embodiment, a 112VAC converter may be used.

FIG. 5 is a top-down view of cooling loop 305, connector 505, cooling plate 418, and heat sink 415 in accordance with an embodiment. While for illustrative purposes various components are shown separated in FIG. 5, in operation, cooling loop 305 is connected to connector 505, connector 505 is connected to cooling plate 418, and cooling plate 418 is connected to, or integrated with, heat sink 415. Cooling plate 418 comprises a thermoelectric cooling mechanism, such as a Peltier plate. To connect cooling loop 305 to cooling plate 418, a connector 505, having a first, flat side 512 (attached to cooling plate 418) and a second, curved side 514 (to attached to cooling loop 305), is used.

In one embodiment, cooling loop 305 may comprise aluminum. Cooling loop 305 fits into chamber 210, and has a diameter approximately the same as the diameter of chamber 210. Cooling loop 305 may have a width between 1 inches and 3 inches, for example.

Connector assembly 335 allows a beverage to flow out from a bottle and be dispensed via dispensing mechanism 120. Connector assembly 335 also ensures that a carbonated beverage stored in a bottle 360 remains pressurized and carbonated, by injecting compressed air into an inflatable object within the bottle as the volume of the liquid in the bottle decreases due to its being dispensed.

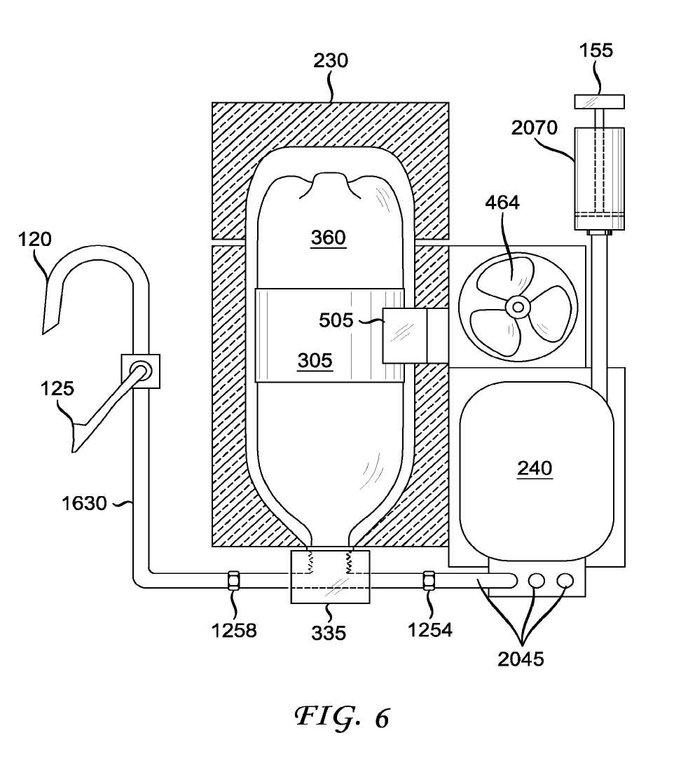

FIG. 6 shows a cross-section view of certain components of beverage dispensing system 100 in accordance with an embodiment. Bottle 360 is held by cooling loop 305 within bottle holder 230. Bottle 360 is connected to connector assembly 335. A tube 1630 is connected to an outlet 1258 of connector assembly 335. Tube 1630 curves upward in front of bottle holder 230, ending at dispensing mechanism 120. Dispensing handle 125 is connected to tube 1630.

Dispensing mechanism 120 allows beverages to be dispensed to a user in a manner commonly used at soda fountains. Specifically, dispensing mechanism comprises a valve that may be opened and closed by moving dispensing handle 125. When dispensing handle 125 is pressed, the valve opens, allowing pressurized beverage liquid to flow out from bottle 360 to a cup held by the user.

An inlet 1254 of connector assembly 335 is connected to one of a plurality of outlets 2045 of compressed air reservoir 240. Also shown in FIG. 6 is fan 464 and a pressure pump 2070, including pump handle 155.

Compressed air reservoir 240 supplies compressed air to bottles 360 to expand the inflatable object within bottle 360, thereby occupying the space vacated by any beverage that is dispensed, consequently maintaining the partial pressure of the carbon dioxide in the liquid, and the carbon dioxide concentration in the liquid, as the beverage is dispensed. The pressure provided by compressed air reservoir 240 also facilitates the flow of the beverage for dispensing.

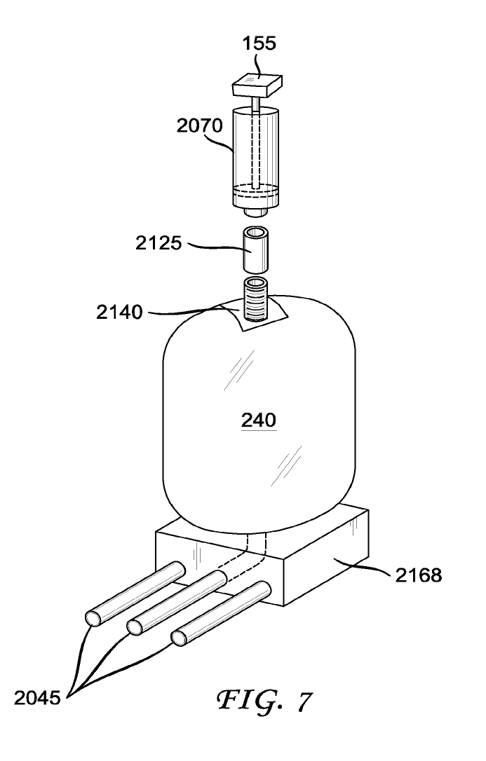

FIG. 7 shows compressed air reservoir 240 in accordance with an embodiment. Compressed air reservoir 240 is disposed on a base element 2168 having three outlets 2045. Pump 2070 (shown with pump handle 155) is connected to the top of reservoir 240 via a tube 2125 and a connecting mechanism 2140.

In one embodiment, reservoir 240 is a balloon approximately the size of a two-liter beverage bottle, which can withstand up to 100 psi of compressed air. In other embodiments, reservoir 240 may have other configurations and other sizes. Pump 2070 pumps air into reservoir 240. Pump 2070 may be electrical or manually operated. In one embodiment, reservoir 240 is connected to the dispensing mechanism 120 via a one-way pressure valve (not shown). The pressure within reservoir 240 is maintained at a predetermined level. When the air pressure in bottle 360 is lower than the pressure of reservoir 240, the compressed air within reservoir 240 is injected into an inflatable object within the bottle, bringing the pressure of the bottle up to that of the reservoir.

In one embodiment, when the pressure of reservoir 240 is below the predetermined level, an alert may be displayed on display 142 (on exterior of beverage dispensing system 100, as shown in FIG. 1). A user may then employ pump handle 155 and use pump 2070 to increase the air pressure in reservoir 240 to the desired level.

In some embodiments, a powered compressed air providing device may be used to provide compressed air (without a compressed air reservoir).

It has been observed that existing products designed to prevent loss of carbonation within a beverage bottle by injecting pressurized air into the bottle do not successfully prevent loss of carbonation. It has been determined that this problem may be addressed more successfully by controlling the volume of the air in the bottle (rather than the pressure of the air in the bottle). Because of the principle of partial pressures, the release of carbon dioxide from a carbonated beverage is primarily determined by the differential between the partial pressure of the carbon dioxide in the beverage and the partial pressure of carbon dioxide within the air within the bottle. It is therefore desirable to maintain an equilibrium or a substantial equilibrium between the partial pressure of the carbon dioxide in the beverage and the partial pressure of carbon dioxide within the air within the bottle.

In accordance with an embodiment, the volume of air within a bottle containing a carbonated beverage is controlled in order to maintain a constant or substantially constant volume of the air within the bottle as the beverage is dispensed. By maintaining a constant or substantially constant volume of air within the bottle, a constant or substantially constant partial pressure of carbon dioxide within the air is maintained, in order to maintain an equilibrium or substantial equilibrium between the partial pressure of carbon dioxide in the air within the bottle and the carbon dioxide within the carbonated beverage. When such an equilibrium is maintained, little or no release of carbon dioxide from the carbonated beverage into the air occurs.

In accordance with an embodiment, an inventive stopper cap is attached to a bottle containing a carbonated beverage. The bottle is then connected to connector assembly 335. The stopper cap is coupled to an inflatable object which fits into the bottle and expands within the bottle to control the volume of an air pocket within the bottle.

Advantageously, connector assembly 335 is configured to allow a user to connect, and to disconnect, bottles in a simple manner. In one embodiment, a user connects a beverage bottle, such as a two-liter bottle of soda, to connector assembly 335 by removing the ordinary cap that is on the bottle at time of purchase with an inventive stopper cap adapted to connect easily to connector assembly 335. The user may do so while the bottle is placed upright on a countertop, for example.

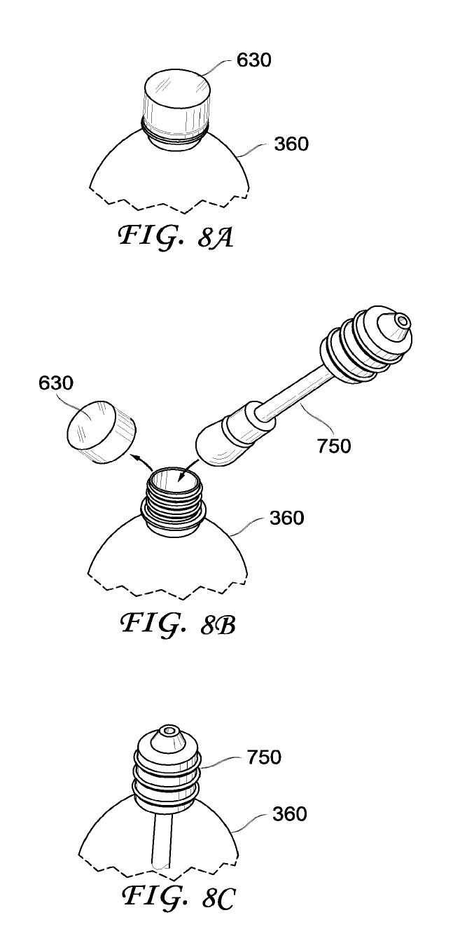

In accordance with an embodiment, an inventive stopper cap is placed on a bottle containing a carbonated beverage. FIGS. 8A-8C illustrate an embodiment in which a user replaces the ordinary cap of a beverage bottle with a stopper cap. FIG. 8A shows a beverage bottle 360 having an ordinary cap 630. For example, cap 630 may be a twist-off cap of the type commonly used on 2-liter bottles of soda. Referring to FIG. 8B, a user removes cap 630 and places a stopper cap 750 onto bottle 360. For example, stopper cap 750 may be twisted onto bottle 360. FIG. 8C shows bottle 360 with stopper cap 750 attached in accordance with an embodiment.

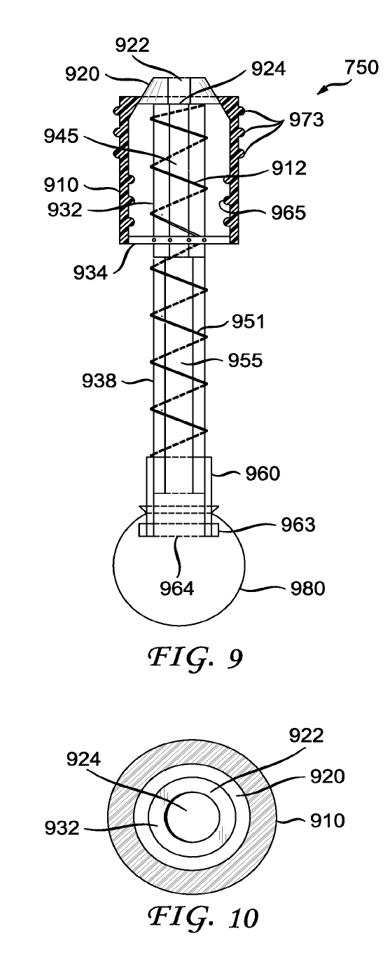

FIG. 9 shows components of stopper cap 750 in accordance with an embodiment. Stopper cap 750 comprises an outer casing 910 and a stopper 920. A first set of threads 973 are disposed on the exterior surface of outer casing 910, and a second set of threads 965 are disposed on the interior surface of outer casing 910. Stopper 920 comprises an opening 922. A hole 924 is disposed at the interior end of opening 922.

Stopper cap 750 also comprises a first tube portion 932, which is attached to stopper 920. First tube portion 932 is disposed substantially within outer casing 910 and forms an air channel 945 within stopper cap 750. A spring 912 is disposed inside stopper cap 750, and is attached to stopper 920 and to a wall 934 at the opposite end of stopper cap 750. Spring 912 may wind around first tube portion 932, for example. Spring 912 exerts pressure on stopper 920, holding stopper 920 in a closed position.

FIG. 10 is a top view of stopper cap 750 in accordance with an embodiment. Outer casing 910 is configured peripherally around stopper 920. From the top view shown in FIG. 10, opening 922 is visible, providing a view of first tube portion 932 and hole 924 at the interior end of opening 922.

Returning to FIG. 9, a second tube portion 938 is attached, at a first end, to first tube portion 932. A second end of second tube portion 938 comprises a sliding piece 960. For example, sliding piece 960 may be a cylindrical piece fitted concentrically around second tube portion 938 and may be adapted to slide along second tube portion 938. Sliding piece 960 includes an end cap 963 having a hole 964 that allows air to flow into and out of second tube portion 938. In one embodiment, sliding piece 960 is adapted to slide up and down the length of second tube portion 938. A spring 951 exerts a force on sliding piece 960, maintaining sliding piece 960 in a first position at the end of second tube section 938.

An inflatable object 980 is attached to sliding piece 960. In the illustrative embodiment, inflatable object 980 is a balloon. For example, the mouth of balloon 980 may be fitted and sealed around sliding piece 960. Balloon 980 may comprise, for example, rubber or a similar material.

Second tube portion 938 comprises an air channel 955 through which air may flow between first tube portion 932 and balloon 980.

Thus, stopper 920, first tube portion 932 and second tube portion 938 together form a channel by which air may flow from outside stopper cap 750 into balloon 980 (and in the opposite direction). For example, air may flow into opening 922 of stopper 920, through hole 924, into and through first tube portion 932, through second tube portion 938, and into balloon 980.

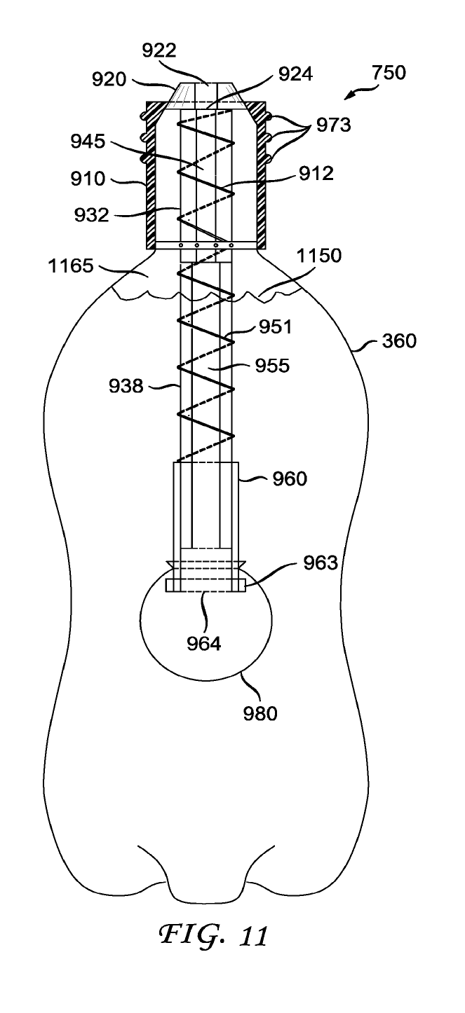

FIG. 11 shows stopper cap 750 attached to bottle 360 in accordance with an embodiment. Bottle 360 may be a bottle of any size. In an illustrative embodiment, bottle 360 is a two liter (2-liter) bottle of soda, or other carbonated beverage. In other embodiments, bottle 360 is a bottle having another size. In the example of FIG. 11, bottle 360 is full or nearly full of a soda 1150. Accordingly, soda 1150 reaches nearly to stopper cap 750, leaving an air pocket 1165 in bottle 360. Under normal conditions, the air in air pocket 1165 contains an amount of carbon dioxide that is in equilibrium with the carbon dioxide in soda 1150. While stopper cap 750 is attached to bottle 360, there is little or no additional transfer of carbon dioxide from soda 1150 to the air in air pocket 1165.

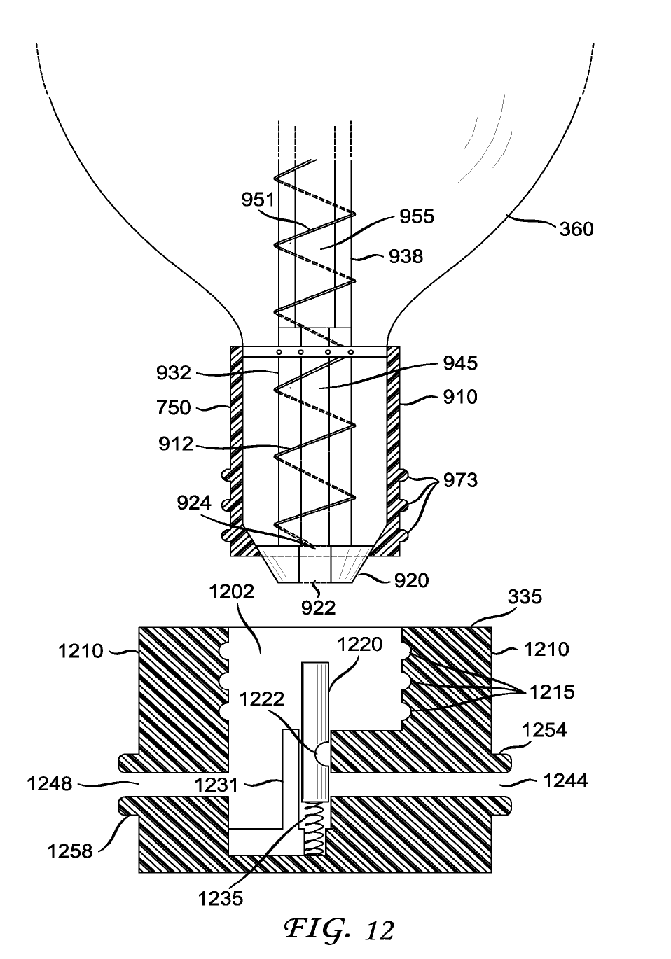

In accordance with an embodiment, after a user attaches stopper cap 750 to bottle 360, the user turns bottle 360 upside down and connects the bottle to connector assembly 335. FIG. 12 shows bottle 360 with stopper cap 750 and a cross-section of connector assembly 335 in accordance with an embodiment.

Connector assembly 335 comprises an outer casing 1210, which comprises a cavity 1202. Grooves 1215 are disposed on the sides of cavity 1202. Casing 1210 also includes an inlet 1254, an input channel 1244, an output channel 1248, and an outlet 1258. Connector assembly 335 also includes a wall 1231, which may in some embodiments be joined to casing 1210. A sliding valve 1220 is disposed within a well formed between wall 1231 and casing 1210. Sliding valve 1220 is supported by a spring 1235 and may accordingly move up and down as spring 1235 extends and contracts.

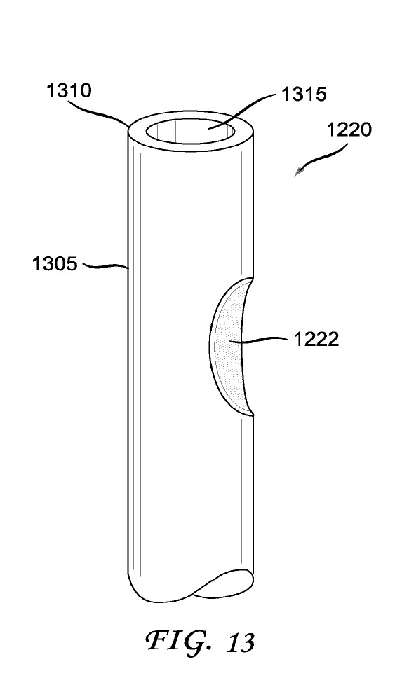

FIG. 13 shows sliding valve 1220 in accordance with an embodiment. Sliding valve 1220 comprises a cylindrical tube 1305 and an end 1310. Cylindrical tube 1305 is hollow or substantially hollow. End 1310 comprises an end hole 1315 having a diameter smaller than the diameter of tube 1305. End hole 1222 allows air to flow into and out of tube 1305. Sliding valve 1220 also includes a side hole 1222 on a side of tube 1305. Side hole 1222 allows air to flow into and out of tube 1305.

Returning to FIG. 12, when spring 1235 is extended, sliding valve 1220 is in a first position in which side hole 1222 is not aligned with input channel 1244. When sliding valve 1220 is in the first position, as shown in FIG. 12, no air can flow from input channel 1244 into valve 1220.

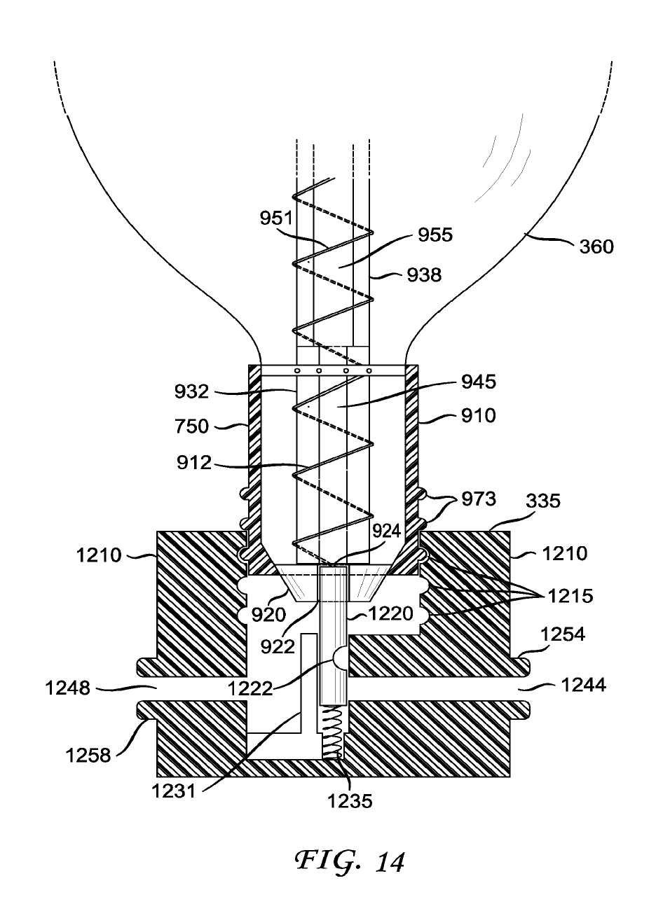

In the illustration of FIG. 12, bottle 360 and stopper cap 750 are positioned above connector assembly 335 and are not yet engaged with connector assembly 335. In the illustrative embodiment, stopper cap 750 may be engaged with connector assembly 335 by lowering stopper cap 750 into cavity 1202 and twisting stopper cap 750 so that threads 973 (on stopper cap 750) engage grooves 1215 (in cavity 1202 of connector assembly 335). FIG. 14 shows bottle 360 and stopper cap 750 after the user has twisted stopper cap 750 partially into connector assembly 335, in accordance with an embodiment.

Specifically, in the example of FIG. 14, threads 973 have begun to engage with grooves 1215. As stopper cap 750 descends into cavity 1202, opening 922 of stopper 920 receives the top end of sliding valve 1220. In the example of FIG. 14, the top end of sliding valve 1220 touches (or nearly touches) first tube portion 932.

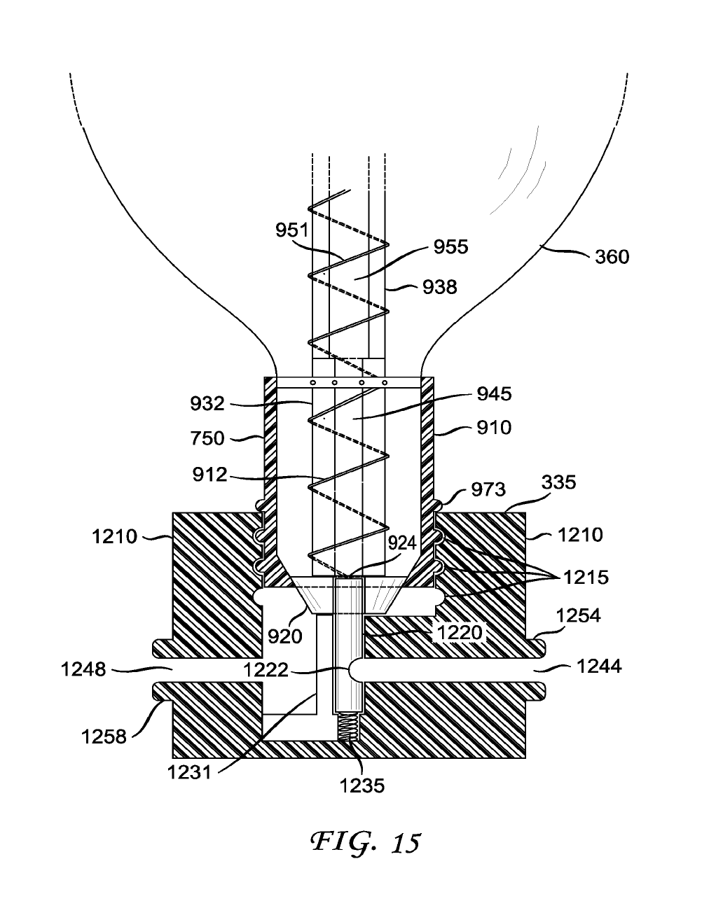

FIG. 15 shows bottle 360 and stopper cap 750 after the user has twisted stopper cap 750 further into connector assembly 335 in accordance with an embodiment. As the user continues to twist stopper cap 750, threads 973 engage further with grooves 1215. Stopper cap 750 descends, and sliding valve 1220 is forced downward by the inner edge of first tube portion 932 until side hole 1222 (of valve 1220) is aligned with input channel 1244. Stopper 920 descends until it touches wall 1231 and casing 1210.

Because side hole 1222 is aligned with input channel 1244, air may now flow through inlet 1254 into input channel 1244, and through side hole 1222 into sliding valve 1220. The air may further flow from sliding valve 1220 up into channel 945 of first tube portion 932, and into air channel 955 of second tube portion 938.

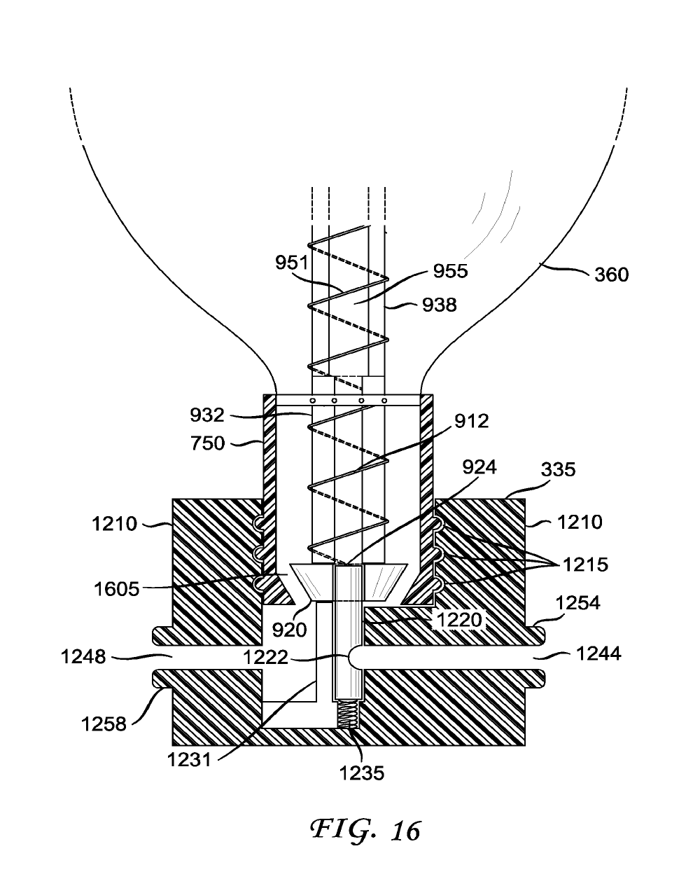

FIG. 16 shows bottle 360 and stopper cap 750 after the user has twisted stopper cap 750 further into connector assembly 335 in accordance with an embodiment. As the user continues to twist stopper cap 750, outer casing 910 of stopper cap 750 descends further; however stopper 920 remains in place and does not descend further as it is blocked by wall 1231 and casing 1210. As a result, a channel 1605 opens between stopper 920 and outer casing 910.

In accordance with an embodiment, liquid may flow from bottle 360 down through channel 1605, and out via output channel 1248 and outlet 1258. As a result, a user may now dispense soda from bottle 360.

In accordance with an embodiment, as soda is dispensed from bottle 360, air flows into balloon 980. In one embodiment, an amount of air sufficient to occupy the space vacated by the dispensed soda may be injected into balloon 980, thereby controlling the volume of air pocket 1165. In another embodiment, balloon 980 inflates until the air pressure in air pocket 1165 is equal or substantially equal to the air pressure of compressed air reservoir 240. The air injected into balloon 980 does not mix with the air in air pocket 1165. Consequently, balloon 980 inflates sufficiently to ensure that the volume of air pocket 1165 remains substantially unchanged. As the volume of the air pocket is maintained constant or substantially constant, the partial pressure of carbon dioxide within the air pocket remains unchanged or substantially unchanged. Therefore, an equilibrium or substantial equilibrium is maintained between the partial pressure of the carbon dioxide in the air pocket and the partial pressure of the carbon dioxide in the carbonated beverage. As a result, little or no release of carbon dioxide from the soda 1150 into air pocket 1165 occurs, and soda 1150 remains carbonated even as the quantity of soda within bottle 360 decreases.

Specifically, in accordance with an embodiment, when the air pressure in bottle 360 falls below the air pressure in compressed air reservoir 240, air flows into balloon 980 via inlet 1254, input channel 1244, side hole 1222, sliding valve 1220, first tube section 932 and second tube section 938. Accordingly, in response to the decrease in air pressure within bottle 360, balloon 980 inflates until the air pressure in bottle 360 is equal to the air pressure of compressed air reservoir 240. As balloon 980 expands, the volume of air pocket 1165 decreases.

In one embodiment, the air pressure in compressed air reservoir 240 is maintained at approximately 30 psi (which is approximately the air pressure within a newly purchased bottle of carbonated soda). Consequently, as soda is dispensed from bottle 360, balloon 980 expands to maintain the air pressure in bottle 360 at approximately 30 psi. For example, as beverage is dispensed from the bottle, a volume of air sufficient to cause balloon 980 to expand by a volume sufficient to occupy the volume vacated by the dispensed beverage may flow from compressed air reservoir 240 into balloon 980. As a result, the volume of air pocket 1165 is maintained constant or substantially constant, thereby maintaining a constant or substantially constant partial pressure of carbon dioxide within air pocket 1165. Therefore, equilibrium or substantial equilibrium is maintained between the partial pressure of the carbon dioxide in air pocket 1165 and the partial pressure of the carbon dioxide in the carbonated beverage. As a result, little or no release of carbon dioxide from the carbonated beverage into air pocket 1665 occurs, and the beverage remains carbonated.

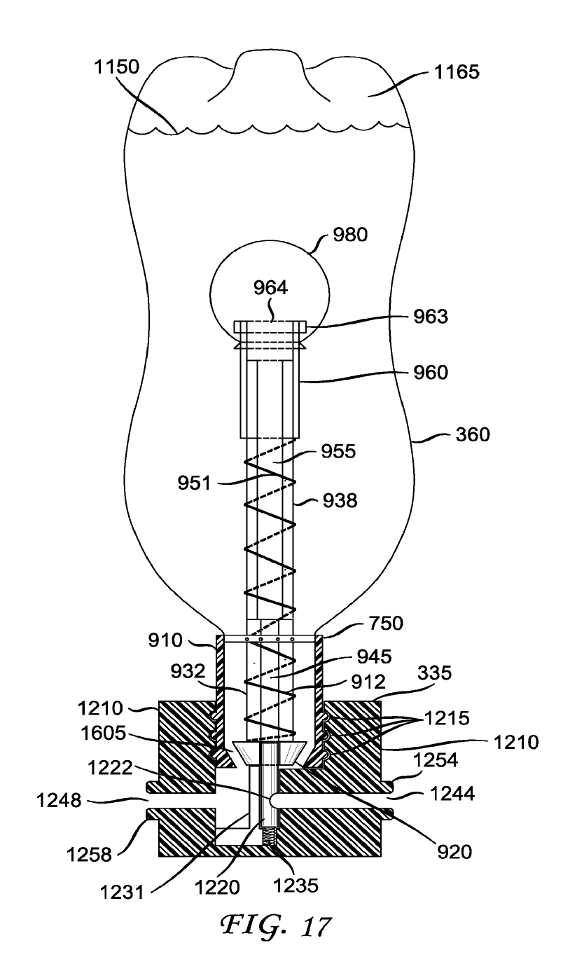

FIG. 17 shows bottle 360 and stopper cap 750 connected to connector assembly 335 in accordance with an embodiment. In this example, soda 1150 nearly fills bottle 360. A relatively small quantity of air forms an air pocket 1165 within the bottle.

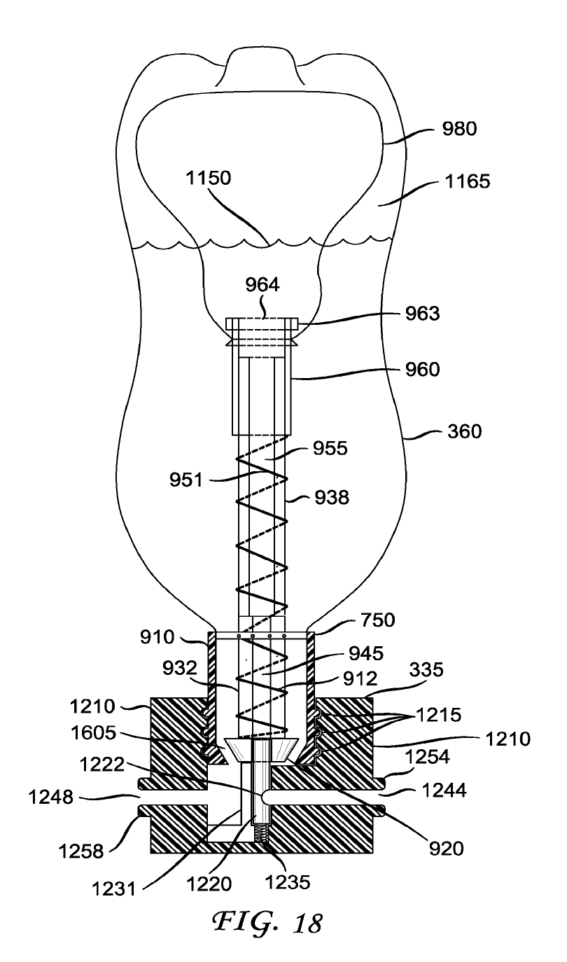

Supposing that a user dispenses a selected quantity of soda from bottle 360, the quantity of soda 1150 within bottle 360 decreases as a result. FIG. 18 shows bottle 360 and stopper cap 750 connected to connector assembly 335 in accordance with an embodiment. In this example, because the user has dispensed soda from the bottle, the quantity of soda 1150 has decreased compared to that shown in FIG. 17.

As the level of soda 1150 decreases, the volume of air pocket 1165 increases. However, as the volume of air pocket 1165 increases, the air pressure within air pocket 1165 (and within bottle 360) decreases. When the air pressure within bottle 360 falls below the air pressure of compressed air reservoir 240, air flows into balloon 980 and balloon 980 expands. As shown in FIG. 18, balloon 980 has expanded (compared to FIG. 17) and fills a portion of the space above the surface of soda 1150. For example, a volume of air sufficient to cause balloon 980 to expand by a volume sufficient to occupy the volume vacated by the dispensed beverage may flow into balloon 980. As a result, the volume of air pocket 1165 remains substantially unchanged (compared to FIG. 17), and soda 1150 remains carbonated. When discussed herein, the volume of air pocket 1165 does not include, and does not mix with, the volume of air within balloon 980.

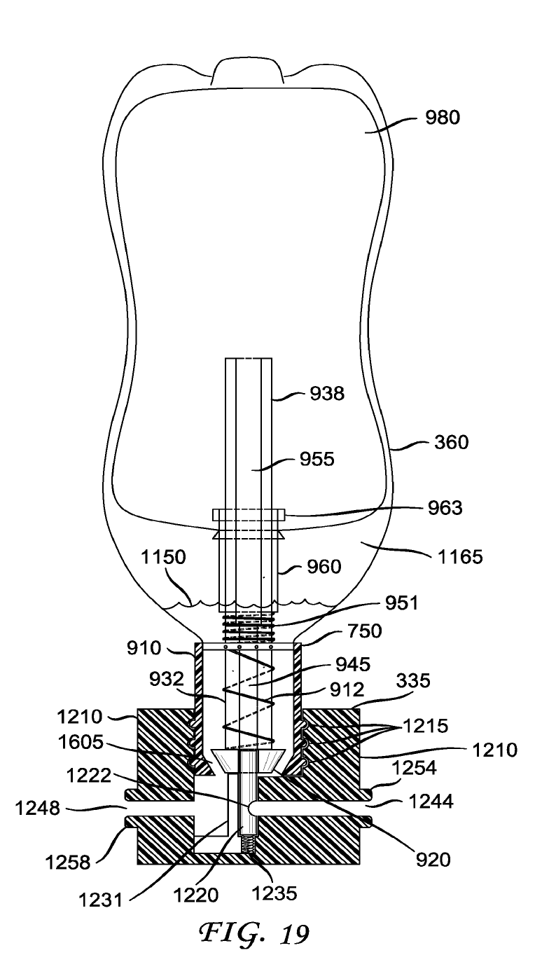

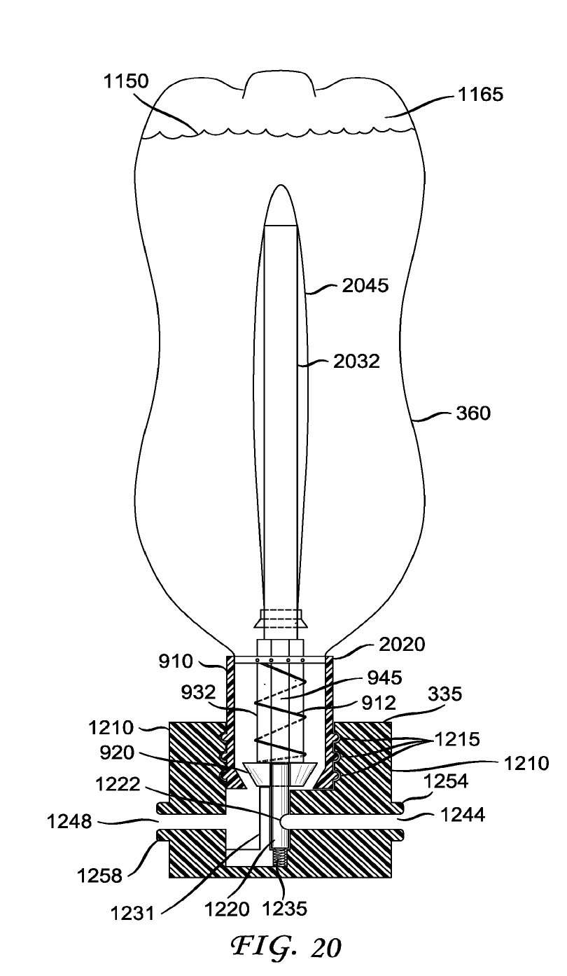

Supposing that a user dispenses additional soda from bottle 360, the quantity of soda 1150 within bottle 360 decreases further as a result. FIG. 19 shows bottle 360 and stopper cap 750 connected to connector assembly 335 in accordance with an embodiment. Because the user has dispensed additional soda from the bottle, the quantity of soda 1150 has decreased further compared to that shown in FIG. 18.

Again, because the level of soda 1150 decreases further, the volume of air pocket 1165 increases and the air pressure within air pocket 1165 (and within bottle 360) decreases. When the air pressure within bottle 360 falls below the air pressure of compressed air reservoir 240, air flows into balloon 980 and balloon 980 expands. As shown in FIG. 19, balloon 980 has expanded further (compared to FIG. 18) and fills a substantial portion of the space above the surface of soda 1150.

As balloon 980 expands, balloon 980 exerts a downward force on sliding piece 960, and pushes sliding piece 960 downward along second tube section 938. As sliding piece 960 is pushed downward, spring 951 contracts (increasing the upward force on sliding piece 960), until the forces on sliding piece 960 are in equilibrium.

Because balloon 980 has expanded to fill a substantial portion of the space above the surface of soda 1150, the volume of air pocket 1165 remains substantially unchanged (compared to FIG. 18). Consequently, an equilibrium of the partial pressures of carbon dioxide is maintained or substantially maintained, and little or no carbon dioxide is released from soda 1150, and soda 1150 remains carbonated.

While in the illustrative embodiment, an equilibrium of partial pressures is substantially maintained, in another embodiment, balloon 980 may expand to fill a portion of the space above the surface of soda 1150, thereby reducing the volume of air pocket 1165; however, the volume of air pocket 1165 may increase minimally. In this embodiment, because the volume of air pocket 1165 increases, the partial pressure of carbon dioxide in air pocket 1165 decreases, and some carbon dioxide is released from the carbonated beverage. However, the release of carbon dioxide is minimized, and the beverage remains substantially carbonated.

In an alternative embodiment, beverage dispensing system 100 may include a separate ice chamber with an ice dispenser. In one embodiment, a user places ice into the chamber to be kept cold. The ice may then be dispensed from the ice dispenser, for example, using a manually operated dispenser.

FIG. 20 shows a bottle and a stopper cap in accordance with another embodiment. Stopper cap 2020 comprises certain components that are similar to those described in the embodiment of FIG. 9, including outer casing 910, a stopper 920, and first tube portion 932. In this embodiment, first tube portion 932 is coupled to a second tube portion 2032. A balloon 2045 is attached to second tube portion 2032. Balloon 2045 may be attached in any suitable manner. For example, balloon 2045 may be attached to a separate cylindrical piece (not shown) that is twisted onto second tube portion 2032. Other methods may be used to attach balloon 2045 to second tube portion 2032.

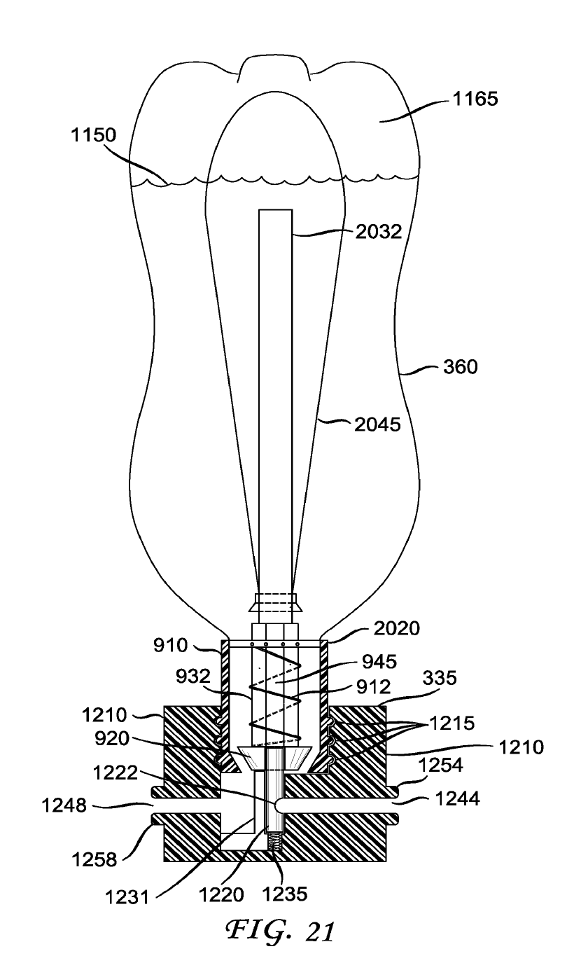

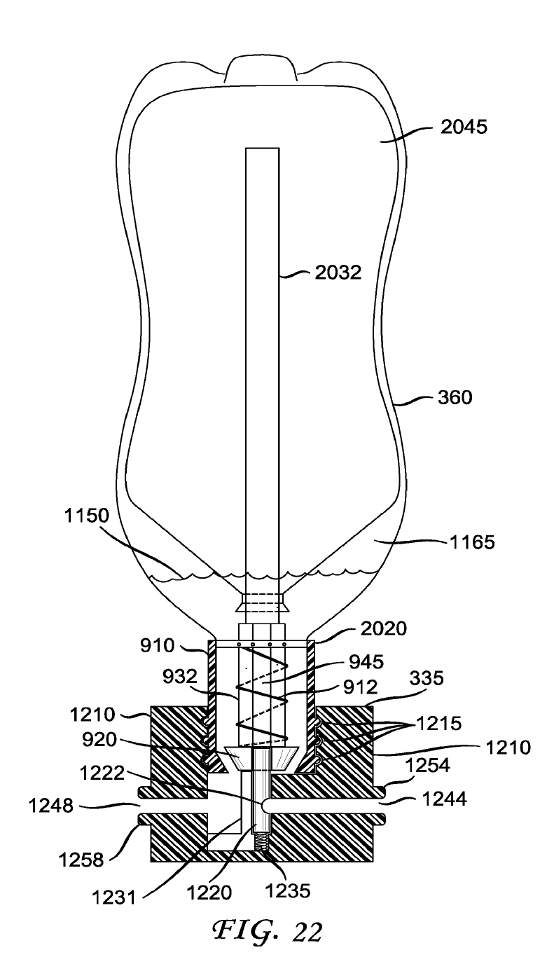

In a manner similar to that described above, when beverage 1150 is dispensed from bottle 360, air flows through first tube portion 932 and second tube portion 2032 and into balloon 2045. Balloon 2045 accordingly inflates, ensuring that air pocket 1165 maintains a constant or substantially constant volume. FIG. 21 shows bottle 360 and stopper cap 2020 in accordance with an embodiment. As shown in FIG. 21, a portion of beverage 1150 has been dispensed, and air has flowed into balloon 2045, causing balloon 2045 to be partially inflated. Consequently, the volume of air pocket 1165 is maintained or substantially maintained. An equilibrium between the partial pressure of carbon dioxide in beverage 1150 and the partial pressure of carbon dioxide in air pocket 1165 is maintained or substantially maintained, and little or no release of carbon dioxide from beverage 1150 occurs within bottle 360.

FIG. 22 shows bottle 360 and stopper cap 2020 in accordance with an embodiment. As shown in FIG. 22, an additional portion of beverage 1150 has been dispensed, and more air has flowed into balloon 2045, causing balloon 2045 to be further inflated. Consequently, the volume of air pocket 1165 is maintained or substantially maintained. An equilibrium between the partial pressure of carbon dioxide in beverage 1150 and the partial pressure of carbon dioxide in air pocket 1165 is maintained or substantially maintained, and little or no release of carbon dioxide from beverage 1150 occurs within bottle 360.

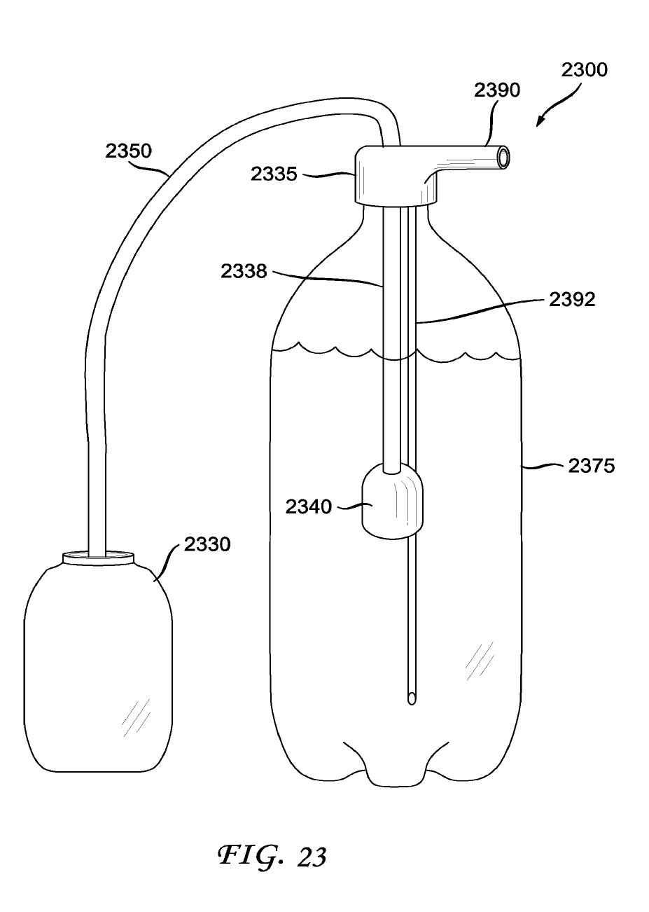

FIG. 23 shows a system for dispensing a carbonated beverage in accordance with another embodiment. System 2300 may be adapted to attach to and dispense a beverage from a single bottle, or from multiple bottles. System 2300 comprises a compressed air reservoir 2330, a cap 2335 comprising a tube 2338 and an inflatable object 2340 attached to the tube. Compressed air reservoir may include a manual pump or an automatic/powered air pressure system. Alternatively, a powered compressed air providing device may be used (without a reservoir). Cap 2335 is attached to a container 2375, such as a bottle, that contains a carbonated beverage. A channel 2350, which may be a tube, for example, connects compressed air reservoir 2330 and cap 2335. Cap 2335 also comprises a dispensing mechanism 2390 for dispensing the beverage from container 2375. In the illustrative embodiment, cap 2335 is placed on container 2375 while container 2375 is upright, and system 2300 operates while container 2375 remains upright. A second tube 2392 coupled to dispensing mechanism 2390 allows dispensing mechanism 2390 to withdraw the beverage from bottle 2375. In a manner similar to that described above, as the carbonated beverage is dispensed from container 2375, compressed air flows from compressed air reservoir 2330 through channel 2350, through cap 2335, and through tube 2338 into inflatable object 2340, causing inflatable object 2340 to expand within container 2375. Due to the expansion of inflatable object 2340, the volume of air within container 2375 is maintained constant or substantially constant, thereby maintaining equilibrium or substantial equilibrium between the partial pressure of carbon dioxide in the air within the container 2375 and the partial pressure of carbon dioxide within the carbonated beverage. Consequently, release of carbon dioxide from the carbonated beverage is prevented or minimized.

In other embodiments, a beverage dispensing and pressurizing system may be structured differently than those described above. For example, while a single balloon is used in the illustrative embodiment, in other embodiments, a plurality of balloons may be coupled to a stopper cap via a tube, and inserted into a beverage container. In such an embodiment, the plurality of balloons may expand as the beverage is dispensed from the container.

While the embodiments described above are discussed for use with a soda or soft drink, the methods and systems described herein may be used to pressurize and dispense containers that hold other types of carbonated beverages, such as beer, champagne, etc.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1-24. (canceled)

25. An apparatus comprising:
a cap adapted to be fitted onto an opening of a beverage container holding a beverage when the beverage container is in a first position in which the beverage is disposed in a bottom part of the beverage container opposite the opening and the beverage is not disposed in a second part of the beverage container that is proximate the opening;
a connecting assembly adapted to receive the cap when the cap is fitted onto the beverage container and the beverage container is in a second position in which the beverage is disposed in the second part of the beverage container that is proximate the opening;
the cap comprising a first channel, wherein the first channel is closed when the cap is not engaged with the connecting assembly, wherein engagement of the cap with the connecting assembly when the beverage container is in the second position causes the first channel to open, allowing a selected portion of the beverage to flow from the beverage container;
wherein dispensing of the selected portion of the beverage from the beverage container causes a decrease in air pressure within the beverage container;
the apparatus further comprising:
an inflatable object coupled to the cap via a tube, the inflatable object being adapted to be inserted into the beverage container, the tube comprising a second channel adapted to transmit air to the inflatable object;
and
a compressed air providing device coupled to the tube, the compressed air providing device being adapted to inject into the inflatable object, in response to the decrease in air pressure within the beverage container, a quantity of air sufficient to cause the inflatable object to expand sufficiently to occupy a volume vacated by the selected portion of the beverage dispensed from the beverage container.

26. The apparatus of claim 25, wherein the beverage container holds a carbonated beverage.

27. The apparatus of claim 26, wherein expansion of the inflatable object sufficiently to occupy the volume vacated by the selected portion of the beverage dispensed from the beverage container results in maintenance of an equilibrium between a first partial pressure within the carbonated beverage and a second partial pressure of an air pocket within the beverage container.

28. The apparatus of claim 25, wherein the connecting assembly comprises:
a casing;
a cavity within the casing, the cavity being adapted to receive the cap, causing the cap to be engaged with the connecting assembly;
an inlet channel adapted to receive compressed air from the compressed air providing device; and
an outlet channel adapted to dispense the beverage from the beverage container.

29. The apparatus of claim 28, wherein:
the connecting assembly further comprises a sliding valve having a first valve position in which air does not flow from the compressed air providing device into the sliding valve and a second valve position in which air passes through from the compressed air providing device into the sliding valve;
the sliding valve is adapted to be engaged with the cap when the cap is engaged with the connecting assembly,
the cap is adapted to cause the sliding valve to move from the first valve position to the second valve position when the cap is engaged in the cavity, allowing air to flow from the sliding valve into the tube.

30. The apparatus of claim 29, wherein the sliding valve is mounted on a spring.

31. The apparatus of claim 30, further comprising:
a cooling system adapted to the cool the beverage.

32. The apparatus of claim 25, wherein the inflatable object comprises a balloon.

33. The apparatus of claim 32, further comprising:
a sliding piece disposed on the tube and adapted to slide along the tube, wherein the balloon is attached to the sliding piece; and
a spring disposed along the tube and attached to the sliding piece, the spring being adapted to push the sliding piece toward an end of the tube.

34. A system for dispensing a carbonated beverage, the system comprising:
a compressed air reservoir adapted to:
store pressurized air at a selected pressure;
an inflatable object adapted fit inside a container holding a beverage;
a cap adapted to fit onto an opening of the container when the container is in a first position in which the beverage is disposed in a bottom part of the container opposite the opening and the beverage is not disposed in a second part of the beverage container that is proximate the opening, the cap comprising:
at least one tube adapted to extend into the container when the cap is fitted onto the container, wherein the inflatable object is coupled to the at least one tube;
a first channel allowing pressurized air to flow through the cap into the inflatable object via the at least one tube; and
a second channel having an open state and a closed state; and
a dispensing mechanism adapted to receive the cap when the cap is fitted onto the container and the container is in a second position in which the beverage is disposed in the second part of the container that is proximate the opening, the dispensing mechanism comprising:
an outer casing;
a cavity adapted to receive the cap; and
a third channel connecting the compressed air reservoir and the first channel, the third channel adapted to allow pressurized air to flow from the compressed air reservoir to the first channel;
wherein:
the second channel is closed when the cap is not engaged with the dispensing mechanism, wherein engagement of the cap with the dispensing mechanism causes the second channel to open, allowing a selected portion of the beverage to flow from the container;
in response to the beverage being dispensed from the container, a quantity of pressurized air sufficient to cause the inflatable object to expand sufficiently to occupy a volume vacated by the dispensed carbonated liquid flows from the compressed air reservoir into the inflatable object, via the third channel, the first channel and the tube, causing the inflatable object to expand inside the container.

35. The system of claim 34, wherein the container comprises a bottle.

36. The system of claim 35, wherein the inflatable object comprises a balloon.

37. The system of claim 36, wherein the third channel comprises at least one tube.

38. The system of claim 37, wherein the cap comprises a twist-on cap adapted to attach to a two liter soda bottle.

39. The system of claim 34, wherein the compressed air reservoir stores air at a pressure selected to inflate the inflatable object within the container sufficiently to cause an air pocket within the container to maintain a substantially constant volume.

40. The system of claim 34, further comprising:
a sliding piece disposed on the at least one tube and adapted to slide along the at least one tube, wherein the inflatable object is attached to the sliding piece; and
a spring disposed along the at least one tube and attached to the sliding piece, the spring being adapted to push the sliding piece toward an end of the at least one tube.

41-43. (canceled)
